(19) United States
(12) Patent Application Publication
(10) Pub. No.: US 2025/0353024 A1
(43) Pub. Date: Nov. 20, 2025

(54) LUMINOUS FOAM APPLICATOR

(71) Applicant: Additive Manufacturing 3D LLC, Loudonville, NY (US)

(72) Inventor: Noah F. Hameroff, Loudonville, NY (US)

(73) Assignee: Additive Manufacturing 3D LLC, Loudonville, NY (US)

(21) Appl. No.: 18/952,586

(22) Filed: Nov. 19, 2024

Related U.S. Application Data
(60) Provisional application No. 63/649,131, filed on May 17, 2024.

(51) Int. Cl. B05B 7/24

(52) U.S. Cl. CPC B05B 7/2494

(57) ABSTRACT

A foam applicator for spraying foam cleaning solution capable of appearing luminescent. The applicator may have an interior chamber for receiving pressurized foam, orifices for discharging foam, and a light source. The body may have an integral compartment for housing and keeping the light source dry. The applicator body may be translucent so that light from the light source gets transmitted and scattered throughout the body, giving the body luminescence. The body may be transparent. The applicator has applications in car washes, hand-held cleaning devices and other cleaning devices.

### CROSS-REFERENCE TO RELATED APPLICATIONS

This application claims the benefit under 35 U.S.C. § 119 (e) of U.S. Provisional Patent Application Ser. No. 63/649,131 filed on May 17, 2024, which is hereby incorporated herein by reference in its entirety.

### TECHNICAL FIELD

The present invention relates to an improved foam applicator.

### BACKGROUND OF THE INVENTION

Soap foam applicators are used for spraying foamed cleaning solutions and have sundry applications, including applications in car washes, mechanized car washes and hand-held cleaning devices. Foam applicators may be hollow tubular structures comprising an interior chamber for receiving pressurized foam from a foam generator and a plurality of discharge orifices for discharging the foam onto a vehicle.

Typically, foam applicators have the singular utility of dispensing foam. There is a need for a foam applicator capable of visual communication to the car wash customer for informational, aesthetic or entertainment purposes. There is a need for a self-luminescent foam applicator. There is a need for a foam applicator provided with an integral light source. There is a need for a luminescent foam applicator that provides customers with a more pleasing or entertaining car wash experience.

Foam applicators operate in wet environments. Exposure to wetness, detergents, and other solutions common in car wash environments may compromise the durability and reliability of the light source. It is desirable to keep the light source and attendant electrical circuitry dry. There is a need for a foam applicator with an integral compartment for protecting the light source from wetness.

The improved foam applicator of the present invention fills these needs.

### SUMMARY OF THE INVENTION

In a first aspect, the present invention provides a foam applicator comprising: a body; an interior chamber for receiving pressurized foam; an orifice for discharging foam from the chamber out of the body; and a light source disposed in the body.

In a second aspect, the present invention provides a foam applicator comprising: a body; an interior chamber for receiving pressurized foam; an orifice for discharging foam from the chamber out of the body; and a compartment for receiving a light source.

In a third aspect, the present invention provides a foam applicator comprising: a body; an opening in the body for receiving for receiving foam; an orifice through the body for discharging foam from the chamber out of the body; and a light source attached to the body; said body comprising material selected from the group consisting of a transparent material and translucent material for transmitting light from the light source through the body.

### BRIEF DESCRIPTION OF THE DRAWINGS

The subject matter that is regarded as the invention is particularly pointed out and distinctly claimed in the concluding portion of the specification. The invention, however, may be best understood by reference to the following detailed description of various embodiments and the accompanying drawings and photographs in which:

FIG. 1A is a perspective view of a foam applicator of the present invention;

FIG. 1B is a rear view of the foam applicator of FIG. 1;

FIG. 1C is a front view of the foam applicator of FIG. 1;

FIG. 1D is a longitudinal cross-sectional side view of the foam applicator on line 1D-1D of FIG. 1C;

FIG. 2 is a cross-sectional view of the foam applicator at line 2-2 of FIG. 1D;

FIG. 3A is a plan view of an alternate embodiment of a foam applicator of the present invention;

FIG. 3B is a side view of the foam applicator of FIG. 3A;

FIG. 3C is a perspective view of the foam applicator of FIG. 3A;

FIG. 3D is a front view of the foam applicator of FIG. 3B;

FIG. 4 is a cross-sectional view of the foam applicator at line 4-4 of FIG. 3B;

FIG. 5A is a perspective view of another alternate embodiment of a foam applicator of the present invention;

FIG. 5B is a side view of the foam applicator of FIG. 5A;

FIG. 5C is a rear view of the foam applicator of FIG. 5B;

FIG. 5D is a front view of the foam applicator of FIG. 5B;

FIG. 5E is a longitudinal cross-sectional side view of the foam applicator on line 5E-5E of FIG. 5D;

FIG. 6A is a perspective view of another embodiment of a foam applicator of the present invention;

FIG. 6B is a front view of the foam applicator of FIG. 6A;

FIG. 6C is a side view of the foam applicator of FIG. 6B;

FIG. 6D is a rear view of the foam applicator of FIG. 6B;

FIG. 6E is a longitudinal cross-sectional side view of the foam applicator on line 6E-6E of FIG. 6D;

FIG. 7 is an exploded view of an assembly of a light strip and foam applicator of the present invention; and

FIG. 8 is an exploded view of an assembly of a foam applicator of the present invention assemble to a foam generator.

### DETAILED DESCRIPTION OF THE INVENTION

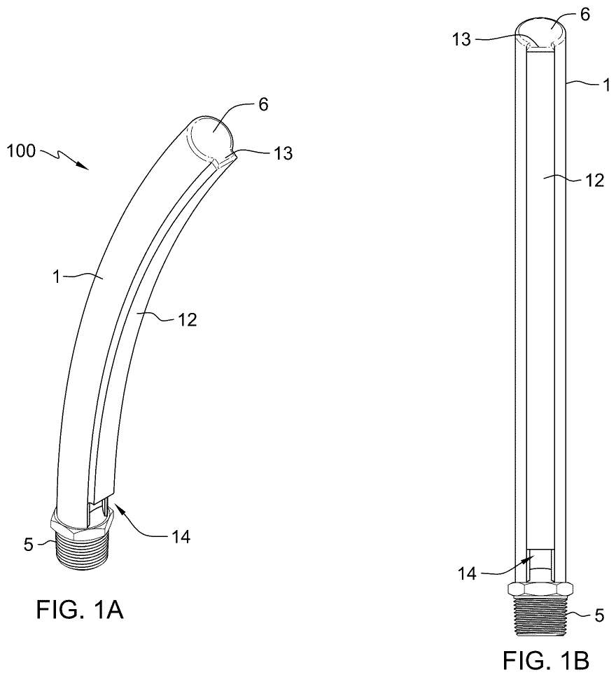

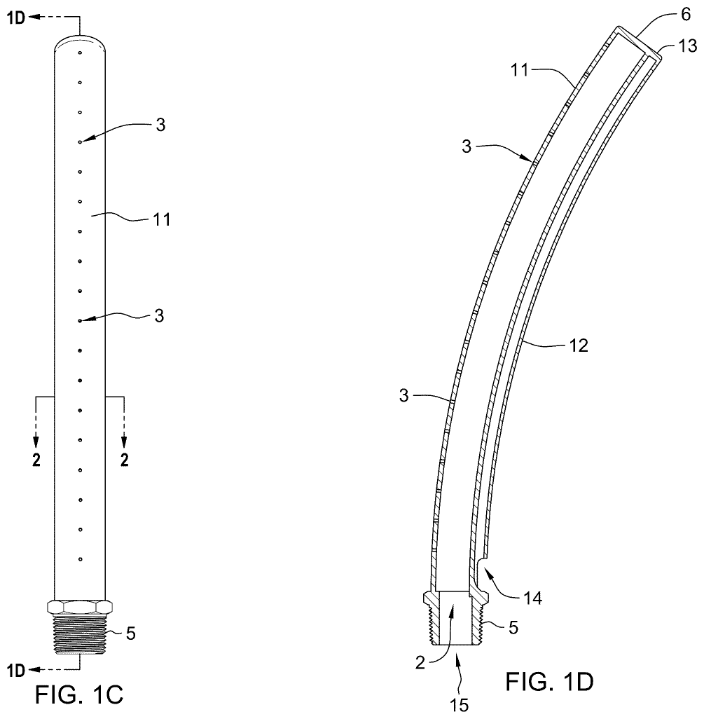

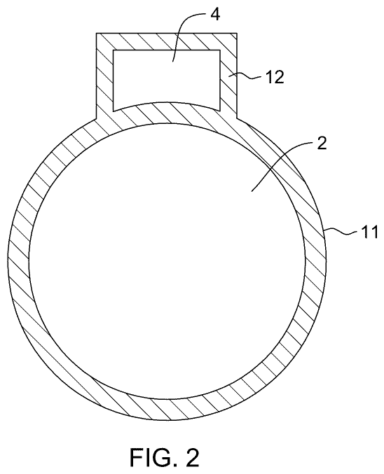

With reference to FIGS. 1A through 1D, FIG. 2 and FIG. 7, one embodiment of an improved foam applicator 100 of the present invention may comprise an elongated, hollow tubular body 1. The body may be bowed, having a curvature in the direction of elongation. The body may comprise a tubular wall 11 defining an interior chamber 2 for receiving foam. The body may further comprise orifices for discharge of foam out of the chamber to the exterior surroundings of the body. The body may comprise threads 5 at an open end and chamber end wall 6 at a closed end distal to the open end. The open end may comprise opening 15. The applicator may further comprise compartment 4 for receiving a light source 7, said compartment defined on its sides by compartment side wall 12 and tubular wall 11 and at an end by compartment end wall 13. Tubular wall 11 forms a barrier between compartment 4 and interior chamber 2 preventing the contents of the chamber from entering the compartment. The compartment may have an opening 14 for providing access to the compartment and for insertion and removal of the light source into and out of the compartment.

In an alternate embodiment, compartment side wall 12 may be on the convex interior side of tubular wall 11, in which case side wall 12 forms a barrier between compartment 4 and interior chamber 2 preventing the contents of the chamber from entering the compartment. In both embodiments the chamber and compartment share a common wall through which light from the light source may be transmitted throughout the body most efficiently without losses and inefficiencies inherent with a separate light compartment or housing. For example, losses and inefficiencies of light transmission through the body would occur where the light must exit a first solid medium, traverse a space filed with a gaseous or liquid medium, and enter a second solid medium. The losses may be exacerbated when the space is filed with foam.

Epoxy, caulk or other suitable sealing compounds may be applied to opening 14 after insertion of the light source for further waterproofing. A gasket, plug or gromet may be provided to seal opening 14. Any other suitable sealing means may be employed.

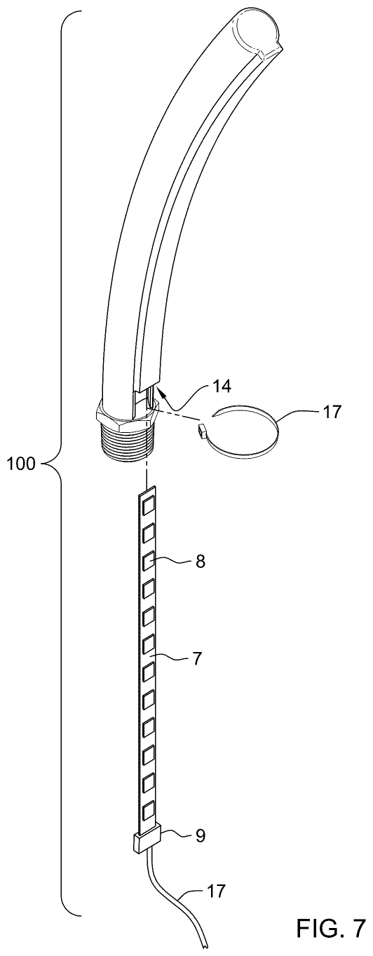

With reference to FIG. 7, the light source may comprise a strip light 7 and electrical connection such as wires 17 to a remotely located alternating current or direct current power source such as a battery or electric utility. The light source may be flexible and may conform to the shape of compartment 4 and conform to the shape of body 1. The light source may provide any color of light and may provide a plurality of colors of light in any combination of colors. The color of the light source may be changeable and may provide any visual light effect, such as blinking lights, or the appearance of motion. The foam applicator may comprise a plurality of light sources, which light sources may be different and independent of another of the light sources. Light sources may be selected to produce any desired visible patterns of shape and color. Zip tie 17 or another clamp or fastening device may be disposed and tightened around the body and strip light to further secure the strip light to the body.

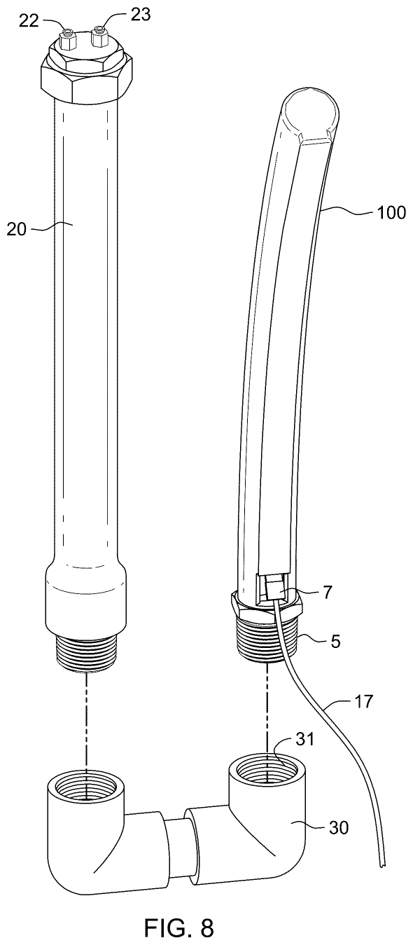

With reference to FIGS. 1A through 1D, FIG. 2 and FIG. 8, the applicator 100 may be connected to a foam generator 20. Said connection may comprise a threaded connection comprising male threads 5 threaded into corresponding female threads 31 of fittings 30, putting the applicator and generator in fluid communication with each other. Alternatively, the foam generator may have female threads, and the foam applicator may be threaded directly into the foam generator. The foam generator may be connected to a pressurized source of a liquid chemical solution via a chemical feed line (not shown) and to a source of pressurized air via an air hose (not shown). The generator may comprise a first port 22 for receiving the pressurized chemical solution and a second port 23 for receiving the pressurized air. The chemical solution may comprise water and soap constituents. The generator may receive the air and chemical solution and agitate the solution to generate pressurized foam. The pressurized foam may flow from the generator into chamber 2 of the applicator through opening 15 and out of the chamber through orifices 3 onto the surface of the automobile or other object being washed by the car wash.

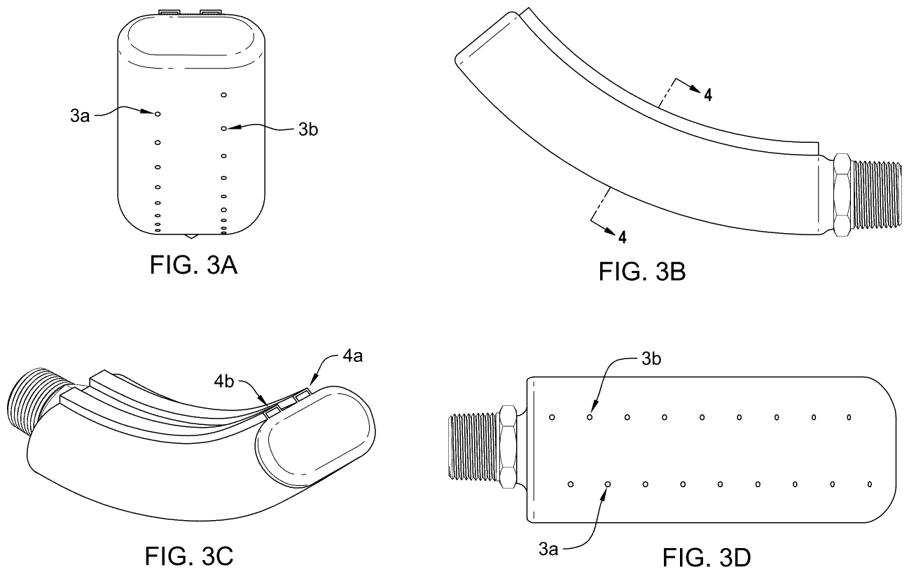

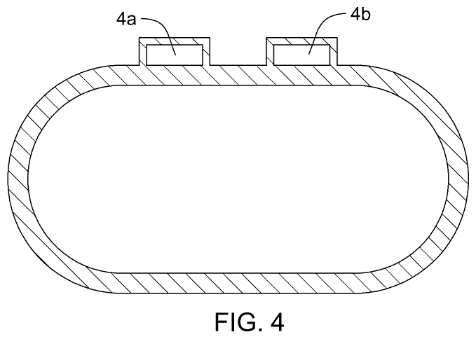

With reference to FIGS. 3A through 3D and 4, an alternate embodiment of the foam applicator of the present invention may comprise a wider body and wider chamber and a plurality of light compartments 4a and 4b. The plurality of light compartments may comprise parallel elongated light compartments for receiving light strips that may conform to the shape of the foam applicator, such as the bowed shape or any other shape. The applicator may further comprise parallel rows of orifices 3a and 3b.

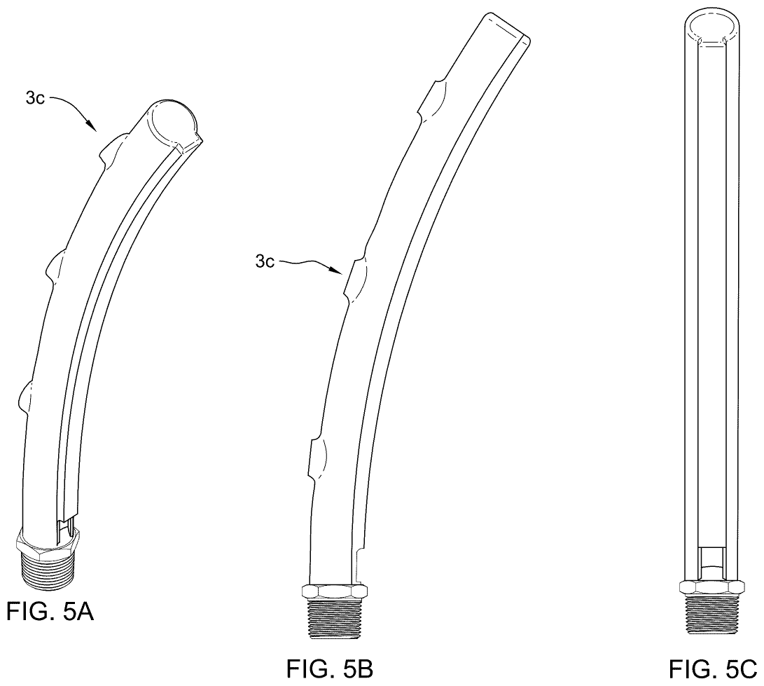

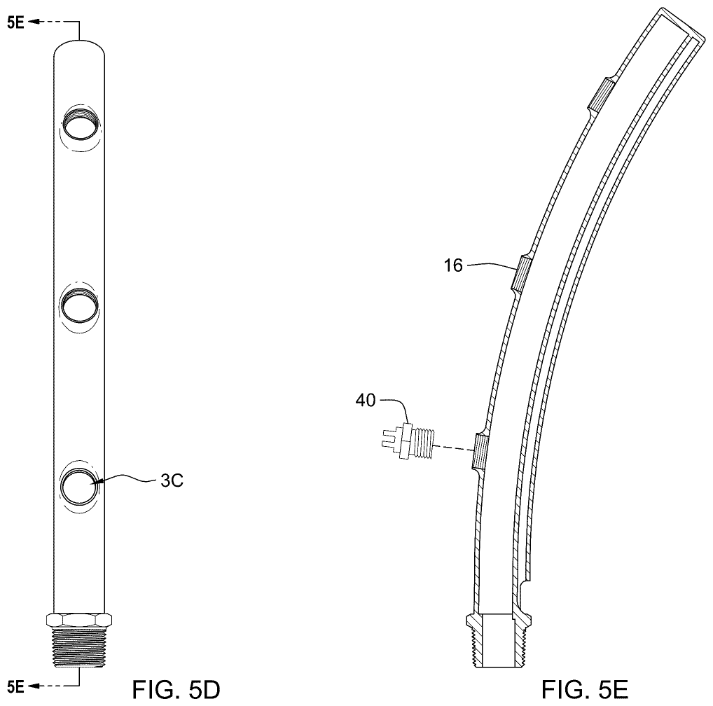

With reference to FIGS. 5A through 5D, another alternate embodiment of the foam applicator of the present invention may comprise one or more large orifices 3c, which orifices may comprise female threads 16 for receiving a male-threaded spray tip 40. Spray tip may comprise nozzles 40. Spray tip 40 may comprise a plurality of nozzles.

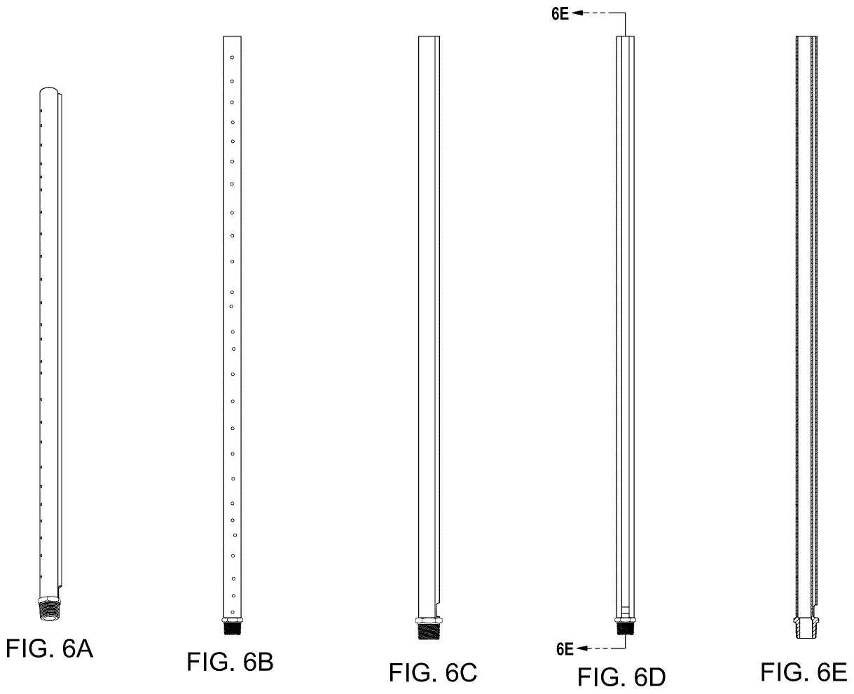

With reference to FIGS. 6A through 6E, another alternate embodiment of the foam applicator of the present invention may comprise a straight tubular body.

Body 100 may comprise transparent material. The body may comprise translucent material. The body may comprise clear material. The body may comprise colorless material. The body may comprise material having color. The body may comprise transparent material with light-diffusing additives. The body may comprise plastic, glass or any other material suitable for low-pressure applications typical of foam applicators such as car washes, mechanized car washes and hand-held cleaning devices. The body may comprise any combination of the foregoing.

In one embodiment, the body may comprise a transparent base polymer such as polycarbonate or acrylic, with light diffusing additives and a textured surface to increase light scattering. Examples of materials comprise transparent PVC, Poly Cyclohexylenedimethylene Terephthalate glycol (PCTG), Polyethylene Terephthalate Glycol (PETG), Transparent Acrylonitrile Butadiene Styrene (ABS) and others.

A foam applicator of the present invention comprising translucent material may appear luminescent throughout the translucent material because light from the light source may diffuse and be carried throughout the translucent material and an appreciable amount of light may be emitted outward from within the translucent material. Therefore, translucent material on the opposite side of the foam applicator from light source may appear luminescent even if the foam inside the chamber may partially or completely block the light. The light from the light source may thusly “bend” around the tube and illuminate translucent material throughout the tube.

A foam applicator body of the present invention may be manufactured by 3D printing (or additive manufacturing) methods, i.e., construction of a three-dimensional object from a CAD model or a digital 3D model in which material may be deposited and added together layer by layer. A single layer may comprise a plurality of thin lines (or filaments) of thermoplastic, resin or other 3D-printable material. The filaments may have the ability to carry light along the lengthwise direction of the filament by internal reflection within the filament while at the same time permitting light to propagate between adjacent filaments and layers. Transverse filaments stacked together to form a tubular shape may carry light around the tube from a light source on one side of the tube. The body of the foam applicator may emit light of the same wavelength and color as that emitted from the light source or may absorb selective wavelengths and emit others.

A foam applicator of the present invention may comprise a frosted finish, matte finish or other textured finish to diffuse light around the foam applicator. Textured finishes may comprise etched or engraved lines, grooves, geometric patterns, non-geometric shapes, starburst patterns and others. Another embodiment of the foam applicator may comprise glass or another transparent material without a textured finish so that foam within the applicator chamber may receive and diffuse more light from the light source and have the appearance of luminescent foam having color consonant with that of the light emitted from the light source. Light emitted from the foam may be more visible through a transparent body.

The body of the foam applicator may comprise a combination of a plurality of portions, each comprising material of different type, different transparency, different translucency, different color, different finish and/or different method of manufacture from another portion. Each such portion may have disparate optical characteristics. Disparate portions and combinations thereof may be selected to produce desired visible patterns of shapes and colors to transmit visual communication to the car wash customer for informational, aesthetic or entertainment purposes.

While the invention has been particularly shown and described with reference to certain embodiments, it will be understood by those skilled in the art that various changes in form and details may be made to the invention without departing from the spirit and scope of the invention as described in the following claims.

We claim:

1. A foam applicator, comprising:
a body;
an interior chamber for receiving pressurized foam;
an orifice for discharging foam from the chamber out of the body; and
a light source disposed in the body.

2. The car wash foam applicator of claim 1, further comprising:
said body comprising material selected from the group consisting of a transparent material and translucent material for transmitting light through the body.

3. The car wash foam applicator of claim 1, further comprising:
said body elongated and bowed lengthwise; and
said light source bowed in conformity with the bow of the body.

4. The car wash foam applicator of claim 1, further comprising:
a compartment for receiving the light source.

5. The car wash foam applicator of claim 1, further comprising:
said orifice comprising threads for receiving a spray tip; and
a spray tip connected to the orifice by a threaded connection.

6. The car wash foam applicator of claim 5, further comprising:
said a spray tip comprising a spray nozzle.

7. A foam applicator, comprising:
a body;
an interior chamber for receiving pressurized foam;
an orifice for discharging foam from the chamber out of the body; and
a compartment for receiving a light source.

8. The car wash foam applicator of claim 7, further comprising:
a light source disposed in said compartment.

9. The car wash foam applicator of claim 7, further comprising:
said body comprising a peripheral wall defining a boundary of said interior chamber;
said compartment comprising a first wall and a second wall extending from the first wall;
said first wall and second wall defining a space interior of the compartment; and
said peripheral wall comprising the first wall.

10. The car wash foam applicator of claim 9, further comprising:
said first wall defining a barrier between the interior chamber and the space interior of the compartment.

11. The car wash foam applicator of claim 9, further comprising:
said second wall defining a barrier between the interior chamber and the space interior of the compartment.

12. A foam applicator, comprising:
a body;
an opening in the body for receiving for receiving foam;
an orifice through the body for discharging foam from the chamber out of the body; and
a light source attached to the body;
said body comprising material selected from the group consisting of a transparent material and translucent material for transmitting light from the light source through the body.
